(19) United States
(12) Patent Application Publication
(10) Pub. No.: US 2023/0373814 A1
(43) Pub. Date: Nov. 23, 2023

(54) CATHODE MATERIAL PRECURSOR AND PREPARATION METHOD AND APPLICATION THEREOF

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP EV RECYCLING CO., LTD., changsha (CN)

(72) Inventors: Qian Wang, Foshan (CN); Jingjing Liu, Foshan (CN); Dingshan Ruan, Foshan (CN); Changdong Li, Foshan (CN)

(21) Appl. No.: 18/227,880

(22) Filed: Jul. 28, 2023

Related U.S. Application Data
(63) Continuation of application No. PCT/CN2021/142369, filed on Dec. 29, 2021.

(30) Foreign Application Priority Data
Jan. 28, 2021 (CN) 202110120828.0

(51) Int. Cl. C01G 53/00; H01M 10/0525

(52) U.S. Cl. CPC C01G 53/50; H01M 10/0525; C01P 2004/03; C01P 2006/40; C01P 2002/78

(57) ABSTRACT

The invention relates to the field of battery materials, and discloses a cathode material precursor and a preparation method and application thereof. The chemical formula of the cathode material precursor is NiₓCo_{y}Mn_{z}(OH)₂, wherein 0.2≤x≤1, 0≤y≤0.5, 0≤z≤0.6, and 0.8≤x+y+z≤1. The cathode material precursor is in a shape of a stack of lamellae, and has a particle size broadening factor K, where K≤0.85. In the invention, the preparation process of the precursor is effectively controlled and adjusted by the controlled crystallization method combined with Lamer nucleation and growth theoretical model. The prepared precursor has morphology characteristics of concentrated particle size distribution and high proportion of {010} active crystal plane family, and has capacity retention up to 91.33% at a rate of 20C.

### CROSS-REFERENCE TO RELATED APPLICATIONS

The present application is a continuation application of PCT application No. PCT/CN2021/142369 filed on Dec. 29, 2021, which claims the benefit of Chinese Patent Application No. 202110120828.0 filed on Jan. 28, 2021. The contents of all of the aforementioned applications are incorporated by reference herein in their entirety.

### TECHNICAL FIELD

The invention relates to the field of battery materials, and in particular to a cathode material precursor and a preparation method and application thereof.

### BACKGROUND

Traditional nickel-metal hydride batteries and lead-acid batteries have effectively realized the transformation from chemical energy to electrical energy, and have made a significant contribution to the development and progress of various industries. However, along this, serious environmental problems inevitably arise. In view of this, Europe put forward in 2007 the ROSH norms prohibiting the introduction of metal substances, such as mercury, lead, cadmium and the like, into Europe to suppress environmental pollution caused by nickel, cadmium, and the like. In the “Thirteenth Five-Year Plan” for The Development of National Strategic Emerging Industries issued by China in 2016, it is clearly pointed out that China will continue to promote the construction of energy-saving, environmental protection and resource recycling industrial systems. At the present stage, it is imperative to fully replace traditional chemical batteries with green and environmentally friendly lithium ion batteries with high energy density, long service life and no memory effect. It is necessary to replace traditional fuel vehicles with hybrid electric vehicles (HEV) and plug-in hybrid electric vehicles (PHEV). This requires that lithium ion power batteries must have the ability to provide sufficient output power for the operation of vehicles, especially for starting. The same requirements for high output power characteristics of power systems are made to electric tools with high speed starting and stopping, underwater weapons and directed energy weapon equipment, and so on. Different from energy type cathode materials, high power type cathode materials require that the cathode materials have higher output power during high rate charge and discharge and are suitable for high rate charge and discharge.

A preparation method of a high power cathode material with a hollow structure is disclosed in the prior art, wherein the hollow structure is realized by removing carbon spheres as the core of a precursor in a high temperature sintering process. Obviously, the difference in diameters of the carbon spheres will lead to difference in the hollow structure of the final sintered materials, which will lead to difference in the power performance of the materials. In addition, the carbon spheres will be converted into CO₂ gas during the sintering process, and the concentrated release of the CO₂ gas and water vapor generated by dehydration of the precursor during the sintering process will produce strong stress, which leads to the risk of cracking of secondary sphere particles. So far, a two-step method for preparing a cathode material for lithium ion batteries with high power and long cycle is also disclosed. The key is to first prepare high power type nickel cobalt manganese oxides precursor by using modified MOFs (metal organic framework compounds) as templates, and then the precursor is subjected to sintering, crushing, washing, drying, coating and second sintering with a lithium source to obtain the final product. The cathode material prepared by this method is excellent in performance, while the preparation process is complex. In addition, benzene hydrocarbons and long-carbon chain alkyl organics are used as emulsifiers in the preparation process of the MOFs material, which is easy to cause environmental pollution. Another high power cathode material with a hollow microsphere structure and a preparation method thereof are also disclosed in the prior art. Different from other methods, during the synthesis of the precursor NiₓCo_{y}Mn_{z}(OH)₂ by co-precipitation method in this preparation method, the precursor composed of fine particles in the center part and slightly larger particles in the outer shell layer is prepared by changing the concentration of ammonium ion in the complexing agent in the nucleation and growth stage of the precursor, and then the particles in the core part shrink toward the outer shell layer during high temperature sintering with a lithium salt and an additive, so that the cathode material with a hollow structure is obtained.

It is not difficult to find that the aforementioned high power materials all have structural characteristics of loose and porous surface and hollow interior. The structure of loose surface allows electrolyte to penetrate into the hollow interior through the gap between the particles, thereby increasing the contact area between active materials and the electrolyte. The structure of hollow interior can effectively decrease the diffusion distance of lithium ions and reduce impedance. The loose and porous surface and the hollow interior complement each other to give the cathode material good power performance.

At present, in the process of preparing a high power cathode material, due to the difference in the inner structure and the outer structure of a precursor, collapse easily occurs during the sintering process. Because this cathode material has a hollow structure, its tap density and compaction density are low, and the particle strength is not high, so that the cathode material is easily broken when a pole piece is rolled, which will destroy the original structure of the cathode material and affect electrical performance of the cathode material. At the same time, the cathode material has large specific surface area, which is beneficial to increase of the output power, however, the contact area between the cathode material and electrolyte increases and the side reactions increase, resulting in low capacity retention.

Therefore, there is an urgent need to develop a cathode material precursor and a cathode material for lithium ion batteries with high power and high capacity retention.

### SUMMARY

The invention aims to solve at least one of the aforementioned technical problems existing in the prior art. For this purpose, the invention provides a cathode material precursor and a preparation method and application thereof. In the invention, the preparation process of the precursor is effectively controlled and adjusted by the controlled crystallization method combined with the Lamer nucleation and growth theoretical model. The prepared precursor has morphology characteristics of concentrated particle size distribution and high proportion of {010} active crystal plane family. The higher the proportion of active crystal plane family, the more the channels provided for deintercalation of lithium ions, and the higher the charge and discharge capacity of the cathode material at high rates, thereby realizing the fast charge function of lithium ion batteries. Therefore, the cathode material for lithium ion batteries has advantages of high power and high capacity retention.

A cathode material precursor is provided in the invention. The cathode material precursor has a chemical formula of NiₓCo_{y}Mn_{z}(OH)₂, where 0.2≤x≤1, 0≤y≤0.5, 0≤z≤0.6, and 0.8≤x+y+z≤1; the cathode material precursor is in a shape of a stack of lamellae, and has a particle size broadening factor K, where K≤0.85.

Preferably, K=(Dᵥ90−Dᵥ10)/Dᵥ50.

Preferably, the cathode material precursor has 40% to 80% active crystal planes that belong to {010} crystal plane family, and the {010} crystal plane family in the cathode material precursor includes active crystal planes (010), (01̅0), (100), (110), (11̅0), and (1̅00).

A preparation method of a cathode material precursor comprises steps of:

Preparing a metal salt solution of nickel, cobalt and manganese; adding thereto a complexing agent and then a precipitating agent to carry out nucleation reaction; adjusting concentrations of the metal salt solution of nickel, cobalt and manganese and the complexing agent to carry out growth reaction; and carrying out filtering, aging, and drying to obtain the cathode material precursor.

Preferably, the complexing agent is ammonia water, and the precipitating agent is at least one selected from a group consisting of sodium hydroxide and sodium carbonate.

Preferably, the metal salt solution of nickel, cobalt and manganese is at least one selected from a group consisting of solutions of sulfates, nitrates, oxalates and hydrochlorides of nickel, cobalt and manganese.

Preferably, the metal salt solution of nickel, cobalt and manganese in the nucleation reaction has a concentration in a range from 0.5 to 2 mol/L, and the metal salt solution of nickel, cobalt and manganese in the growth reaction has a concentration in a range from 1.5 to 3 mol/L.

Preferably, the complexing agent in the nucleation reaction has a concentration in a range from 0.5 to 2.5 g/L, and the complexing agent in the growth reaction has a concentration in a range from 2 to 5 g/L.

Preferably, the nucleation reaction is carried out for 24 to 50 hours, and the growth reaction is carried out for 60 to 100 hours.

Preferably, the nucleation reaction is carried out at a temperature in a range from 40° C. to 70° C., with a stirring rate in a range from 100 to 800 r/min.

A cathode material for lithium ion batteries is also provided in the invention, which is prepared from raw materials comprising the aforementioned cathode material precursor.

Preferably, the cathode material for lithium ion batteries has a chemical formula of LiₐNiₓCo_{y}Mn_{z}M_{b}O₂, where 0.9≤a≤1.4, 0.2≤x≤1, 0≤y≤0.5, 0≤z≤0.6, 0≤b≤0.1, 0.8≤x+y+z≤1, 1≤a/(x+y+z)≤1.5; and M is at least one selected from a group consisting of elements B, Al, Mg, Ti, Fe, Zn, Ga, Ge, Sr, Y, Zr, Nb, Mo, Sn, Sb, La, Ce, W, and Ta.

Preferably, the cathode material for lithium ion batteries has good high-rate discharge performance, and the discharge capacity at a rate of 20C is higher than 90% of the discharge capacity at 0.1C.

A preparation method of a cathode material for lithium ion batteries comprises steps of:

Mixing a cathode material precursor, a lithium source and an additive to obtain a mixture, subjecting the mixture to first sintering and pulverization, and then to second sintering and cooling, to obtain the cathode material for lithium ion batteries.

Preferably, the lithium source is at least one selected from a group consisting of lithium carbonate and lithium hydroxide.

Preferably, the additive is at least one selected from a group consisting of oxides of B, Al, Mg, Ti, Fe, Zn, Ga, Ge, Sr, Y, Zr, Nb, Mo, Sn, Sb, La, Ce, W, and Ta.

Preferably, a molar ratio of metals in the precursor to lithium in the lithium source is 1: (0.9˜1.4).

Preferably, based on the weight of the precursor, the additive is added in an amount of 1000˜6000 ppm.

Preferably, the first sintering is carried out at a temperature of 700° C.˜950° C. for 20˜28 hours; and the second sintering is carried out at a temperature of 300° C.˜600° C. for 3˜8 hours.

A battery comprising the aforementioned cathode material for lithium ion batteries is further provided in the invention.

Power-type cathode materials for lithium ion batteries require that lithium ions still have a relatively high diffusion and migration speed during high rate charge and discharge, so that it is particularly important to ensure that lithium ions can diffuse and migrate along ideal channels. Common cathode materials, such as NCM, NCA, and LiCoO₂, are all in layered structure with R-3m space group, in which lithium ions can only diffuse along a two-dimensional plane. When the direction of diffusion and migration of lithium ions is consistent with the normal direction of the particle surface, the crystal plane corresponding to the particle surface is called as an active crystal plane for diffusion of lithium ions. The higher the proportion of active crystal planes in primary particles, the more the effective diffusion channels of lithium ions, and the better the power performance of the cathode material, which has been confirmed by a large number of scientific and technological literatures. In addition, in the layered cathode material with R-3m space group, the direction of diffusion and migration of lithium ions is parallel to the crystal plane (003), while the {010} crystal plane family in the nickel cobalt manganese hydroxide which is oriented perpendicular to the crystal plane (001) belong to active crystal planes that are conducive to the diffusion of lithium ions. Considering inheritance of the morphology of the precursor during the sintering process, it is not difficult to infer that the higher the proportion of active crystal planes in the precursor, the more the effective channels for diffusion of lithium ions in a high temperature sintered product. It can be seen that the key to obtain a cathode material with good high power performance lies in the preparation of a precursor with a high proportion of active crystal planes.

The invention has the following beneficial effects relative to the prior art.

1. In the invention, the controlled crystallization method, combined with Lamer nucleation-growth theoretical model, is adopted, and the concentrations of transition metal ions and the complexing agent during co-precipitation reaction are adjusted, so that the nucleation number of the precursor crystal nuclei and the proportion of {010} crystal plane family can be controlled by adjusting the time to reach the critical supersaturated concentration Cₛ; on this basis, the growth of the crystal nuclei is controlled by adjusting reaction times to reach the critical supersaturated concentration Cₛ and to reach the minimum nucleation concentration Cₘᵢₙ, so that the precursor with a high proportion of {010} crystal plane family, up to 80%, and concentrated particle size distribution is obtained.

2. Due to inheritance of the morphology of the precursor during the sintering process, the precursor with a high proportion of {010} active crystal plane family still greatly maintains its morphological characteristics after high temperature sintering, which provides more channels for the diffusion and migration of Li⁺, so that the precursor possesses a high power characteristic, and the capacity retention can reach 91.33% even at a rate of 20C.

### BRIEF DESCRIPTION OF DRAWINGS

FIG. 1 is a schematic structure diagram of a precursor with a high proportion of {010} active crystal plane family prepared in Example 1 of the invention; and

FIGS. 2(a) and 2(b) respectively show SEM images of a precursor and a high power cathode material prepared in Example 1 of the invention.

### DETAILED DESCRIPTION

In order to make the technical solutions of the invention more clearly understood by those skilled in the art, the following examples are listed for description. It should be pointed out that the following examples do not limit the scope of protection claimed by the invention.

Unless otherwise specified, the raw materials, reagents or devices used in the following examples can be purchased commercially, or can be obtained by existing known methods.

### Example 1

A cathode material precursor in this example has a chemical formula of Ni_{0.5}Co_{0.3}Mn_{0.2}(OH)₂, is obviously in a shape of a stack of lamellae, and has a particle size broadening factor K, where K=0.75.

A preparation method of the cathode material precursor in this example comprises the following steps of:

According to the molar ratio of Ni:Co:Mn of 5:3:2, dissolving nickel sulfate, cobalt sulfate, and manganese sulfate in deionized water to obtain a metal salt solution with a concentration of 0.5 mol/L, adjusting a concentration of ammonia water as a complexing agent to 0.5 g/L, and adding the metal salt solution, ammonia water, and NaOH into a reaction kettle with a peristaltic pump; carrying out a first reaction for 48 hours with a reaction temperature controlled to 70° C. and a stirring speed of 200 r/min; adjusting the concentration of the metal salt solution to 2 mol/L and the concentration of ammonia water to 2 g/L, then carrying out a second reaction for 72 hours; and subjecting the resulting reaction solution to solid-liquid separation, aging, washing, drying, and sieving, to obtain the precursor Ni_{0.5}Co_{0.3}Mn_{0.2}(OH)₂, with a particle size broadening factor K=0.75 and micro morphology shown in FIG. 2(a).

A cathode material for lithium ion batteries in this example is prepared from raw materials comprising the aforementioned cathode material precursor, and has a chemical formula of Li_{1.15}Ni_{0.5}Co_{0.3}Mn_{0.2}(ZrAl)_{0.03}O₂.

A preparation method of the cathode material for lithium ion batteries in this example comprises the following steps of:

Mixing thoroughly the aforementioned cathode material precursor and lithium carbonate at a molar ratio of 1:1.15, with the doping element M being 1500 ppm Zr and 1500 ppm Al (Zr and Al being doped in the form of Zr and Al oxides), to obtain a mixture; and subjecting the mixture to first sintering for 72 hours at 810° C. in an air atmosphere, pulverization and coating, and then to second sintering for 6 hours at 450° C. in an air atmosphere and cooling, to obtain the cathode material for lithium ion batteries, Li_{1.15}Ni_{0.5}Co_{0.3}Mn_{0.2}(ZrAl)_{0.03}O₂, with micro morphology shown in FIG. 2(b).

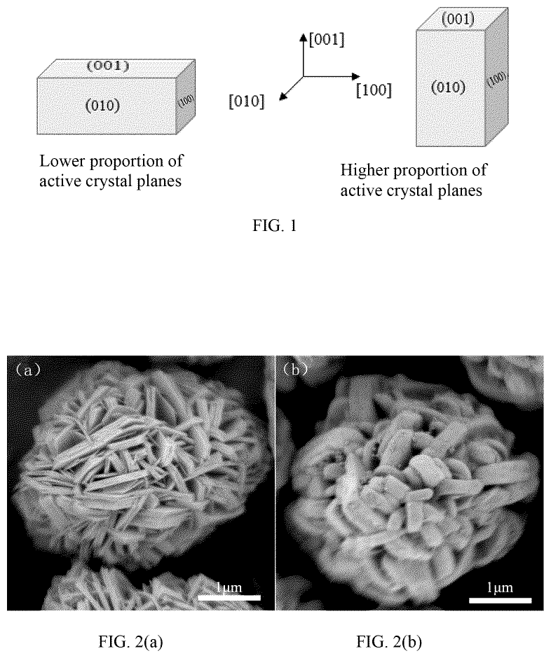

FIG. 1 is a schematic structure diagram of the precursor with a high proportion of {010} active crystal plane family prepared in Example 1 of the invention. The left shows a lower proportion of active crystal planes, and the sum of area of active crystal planes (010), (01̅0), (100), (110), (11̅0), and (1̅00) accounts for less surface area of the cuboid. The right shows a higher proportion of active crystal planes, and the sum of area of the active crystal planes (010), (01̅0), (100), (110), (11̅0), and (1̅00) accounts for more surface area of the cuboid, which indicates that more diffusion channels can be provided for lithium ions.

FIGS. 2(a) and 2(b) respectively show SEM images of the precursor and the high power cathode material prepared in Example 1 of the invention. It can be seen from FIG. 2(a) that the prepared precursor has morphological characteristics of concentrated particle size distribution and high proportion of {010} active crystal plane family. It can be seen from FIG. 2(b) that the prepared cathode material for lithium ion batteries still greatly maintain the morphological characteristics of the precursor after high-temperature sintering, thereby providing more channels for diffusion and migration of Li⁺ and exerting a high power characteristic.

The higher the discharge capacity retention of a cathode material at high rates, the better the power performance of the cathode material. Therefore, the cathode material Li_{1.15}Ni_{0.5}Co_{0.3}Mn_{0.2}(ZrAl)_{0.03}O₂ prepared in Example 1 is produced into a half cell and subjected to charge and discharge tests at different rates to characterize its rate performance. The capacity retention (relative to that at 1C) of the prepared high power type cathode material Li_{1.15}Ni_{0.5}Co_{0.3}Mn_{0.2}(ZrAl)_{0.03}O₂ at different rates is shown in Table 1 below.

TABLE 1

| Rate | 2 C/1 C | 5 C/1 C | 10 C/1 C | 20 C/1 C |
|---|---|---|---|---|
| Capacity retention | 98.21 | 95.84 | 92.37 | 88.19 |
| (%) | | | | |

It can be seen from Table 1 that the capacity retention of the cathode material for lithium ion batteries of Example 1 can be up to 88.19% even at 20C, which indicates that the cathode material for lithium ion batteries possesses a high power characteristic.

### Example 2

A cathode material precursor in this example has a chemical formula of Ni_{0.5}Co_{0.5}(OH)₂, is obviously in a shape of a stack of lamellae, and has a particle size broadening factor of 0.72, where 0.72=(Dᵥ90−Dᵥ10)/Dᵥ50.

A preparation method of the cathode material precursor in this example comprises the following steps of:

According to the molar ratio of Ni:Co of 5:5, dissolving nickel acetate and cobalt acetate in deionized water to obtain a metal salt solution with a concentration of 1 mol/L, adjusting a concentration of ammonia water as a complexing agent to 0.8 g/L, and adding the metal salt solution, ammonia water, and NaOH into a reaction kettle with a peristaltic pump; carrying out a first reaction for 30 hours with a reaction temperature controlled to 60° C. and a stirring speed of 400 r/min; adjusting the concentration of the metal salt solution to 1.5 mol/L and the concentration of ammonia water to 2.5 g/L, then carrying out a second reaction for 60 hours; and subjecting the resulting reaction solution to solid-liquid separation, aging, washing, drying, and sieving, to obtain the precursor Ni_{0.5}Co_{0.5}(OH)₂ with a particle size broadening factor K=0.72.

A cathode material for lithium ion batteries in this example is prepared from raw materials comprising the aforementioned cathode material precursor, and has a chemical formula of Li_{1.25}Ni_{0.5}Co₀₅(BSr)_{0.016}O₂.

A preparation method of the cathode material for lithium ion batteries in this example comprises the following steps of:

Mixing thoroughly the aforementioned cathode material precursor and lithium carbonate at a molar ratio of 1:1.25, with the doping element M being 600 ppm B and 1000 ppm Sr (B and Sr being doped in the form of B and Sr oxides), to obtain a mixture; and subjecting the mixture to first sintering for 18 hours at 790° C. in an air atmosphere, pulverization and coating, and then to second sintering for 5 hours at 550° C. in an air atmosphere and cooling, to obtain the cathode material for lithium ion batteries, Li_{1.25}Ni_{0.5}Co_{0.5}(BSr)_{0.016}O₂.

The high power type cathode material Li_{1.25}Ni_{0.5}Co_{0.5}(BSr)_{0.016}O₂ prepared in Example 2 is produced into a half cell and subjected to charge and discharge tests at different rates to characterize its rate performance. The capacity retention (relative to that at 1C) of the prepared high power type cathode material Li_{1.25}Ni_{0.5}Co_{0.5}(BSr)_{0.016}O₂ at different rates is shown in Table 2 below.

TABLE 2

| Rate | 2 C/1 C | 5 C/1 C | 10 C/1 C | 20 C/1 C |
|---|---|---|---|---|
| Capacity retention | 98.76 | 97.88 | 94.93 | 91.33 |
| (%) | | | | |

It can be seen from Table 2 that the capacity retention of the cathode material for lithium ion batteries of Example 2 can be up to 91.33% even at 20C, which indicates that the cathode material for lithium ion batteries possesses a high power characteristic.

### Example 3

A cathode material precursor in this example has a chemical formula of Ni_{0.2}Mn_{0.6}(OH)₂, is obviously in a shape of a stack of lamellae, and has a particle size broadening factor of 0.73, where 0.73=(Dᵥ90−Dᵥ10)/Dᵥ50.

A preparation method of the cathode material precursor in this example comprises the following steps of:

According to the molar ratio of Ni:Mn of 2:6, dissolving nickel acetate and manganese acetate in deionized water to obtain a metal salt solution with a concentration of 0.5 mol/L, adjusting a concentration of ammonia water as a complexing agent to 2.5 g/L, and adding the metal salt solution, ammonia water, and NaOH into a reaction kettle with a peristaltic pump; carrying out a first reaction for 48 hours with a reaction temperature controlled to 40° C. and a stirring speed of 100 r/min; adjusting the concentration of the metal salt solution to 3 mol/L and the concentration of ammonia water to 5 g/L, then carrying out a second reaction for 100 hours; and subjecting the resulting reaction solution to solid-liquid separation, aging, washing, drying, and sieving, to obtain the precursor Ni_{0.2}Mn_{0.6}(OH)₂ with a particle size broadening factor K=0.73.

A cathode material for lithium ion batteries in this example is prepared from raw materials comprising the aforementioned cathode material precursor, and has a chemical formula of Li_{1.4}Ni_{0.2}Mn_{0.6}(WTa)_{0.03}O₂.

A preparation method of the cathode material for lithium ion batteries in this example comprises the following steps of:

Mixing thoroughly the aforementioned cathode material precursor and lithium carbonate at a molar ratio of 1:1.4, with the doping element M being 2000 ppm W and 1000 ppm Ta (W and Ta being doped in the form of W and Ta oxides), to obtain a mixture; and subjecting the mixture to first sintering for 20 hours at 950° C. in an air atmosphere, pulverization and coating, and then to second sintering for 5 hours at 450° C. in an air atmosphere and cooling, to obtain the cathode material for lithium ion batteries, Li_{1.4}Ni_{0.2}Mn_{0.6}(WTa)_{0.03}O₂.

The cathode material Li_{1.4}Ni_{0.2}Mn_{0.6}(WTa)_{0.03}O₂ prepared in Example 3 is produced into a half cell and subjected to charge and discharge tests at different rates to characterize its rate performance. The capacity retention (relative to that at 1C) of the prepared high power type cathode material Li_{1.4}Ni_{0.2}Mn_{0.6}(WTa)_{0.03}O₂ at different rates is shown in Table 3 below.

TABLE 3

| Rate | 2 C/1 C | 5 C/1 C | 10 C/1 C | 20 C/1 C |
|---|---|---|---|---|
| Capacity retention | 95.72 | 92.57 | 90.43 | 87.59 |
| (%) | | | | |

It can be seen from Table 3 that the capacity retention of the cathode material for lithium ion batteries of Example 3 can be up to 87.59% even at 20C, which indicates that the cathode material for lithium ion batteries possesses a high power characteristic.

### Example 4

A cathode material precursor in this example has a chemical formula of Ni_{0.8}Mn_{0.2}(OH)₂, is obviously in a shape of a stack of lamellae, and has a particle size broadening factor of 0.68, where 0.68=(Dᵥ90−Dᵥ10)/Dᵥ50.

A preparation method of the cathode material precursor in this example comprises the following steps of:

According to the molar ratio of Ni:Mn of 8:2, dissolving nickel acetate and manganese acetate in deionized water to obtain a metal salt solution with a concentration of 2 mol/L, adjusting a concentration of ammonia water as a complexing agent to 0.5 g/L, and adding the metal salt solution, ammonia water, and NaOH into a reaction kettle with a peristaltic pump; carrying out a first reaction for 40 hours with a reaction temperature controlled to 55° C. and a stirring speed of 300 r/min; adjusting the concentration of the metal salt solution to 2.5 mol/L and the concentration of ammonia water to 4 g/L, then carrying out a second reaction for 80 hours; and subjecting the resulting reaction solution to solid-liquid separation, aging, washing, drying, and sieving, to obtain the precursor Ni_{0.8}Mn_{0.2}(OH)₂ with a particle size broadening factor K=0.68.

A cathode material for lithium ion batteries in this example is prepared from raw materials comprising the aforementioned cathode material precursor, and has a chemical formula of Li_{1.15}Ni_{0.8}Mn_{0.2}(Mo)_{0.03}O₂.

A preparation method of the cathode material for lithium ion batteries in this example comprises the following steps of:

Mixing thoroughly the aforementioned cathode material precursor and lithium carbonate at a molar ratio of 1:1.15, with the doping element M being 3000 ppm Mo (Mo being doped in the form of Mo oxide), to obtain a mixture; and subjecting the mixture to first sintering for 30 hours at 750° C. in an air atmosphere, pulverization and coating, and then to second sintering for 8 hours at 300° C. in an air atmosphere and cooling, to obtain the cathode material for lithium ion batteries, Li_{1.15}Ni_{0.8}Mn_{0.2}(Mo)_{0.03}O₂.

The cathode material Li_{1.15}Ni_{0.8}Mn_{0.2}(Mo)_{0.03}O₂ prepared in Example 4 is produced into a half cell and subjected to charge and discharge tests at different rates to characterize its rate performance. The capacity retention (relative to that at 1C) of the prepared high power type cathode material Li_{1.15}Ni_{0.8}Mn_{0.2}(Mo)_{0.03}O₂ at different rates is shown in Table 4 below.

TABLE 4

| Rate | 2 C/1 C | 5 C/1 C | 10 C/1 C | 20 C/1 C |
|---|---|---|---|---|
| Capacity retention | 97.90 | 96.83 | 93.53 | 90.19 |
| (%) | | | | |

It can be seen from Table 4 that the capacity retention of the cathode material for lithium ion batteries of Example 4 can be up to 90.91% even at 20C, which indicates that the cathode material for lithium ion batteries possesses a high power characteristic.

### Comparative Example 1

The precursor in Comparative Example 1 is prepared through a conventional co-precipitation method, and the prepared precursor does not have a high proportion of {010} active crystal plane family.

A preparation method of a cathode material for lithium ion batteries by using the precursor comprises the following steps of:
(1) According to the molar ratio of Ni:Co:Mn of 5:3:2, dissolving nickel sulfate, cobalt sulfate, and manganese sulfate in deionized water to obtain a metal salt solution with a concentration of 2 mol/L, adjusting a concentration of ammonia water as a complexing agent to 2 g/L, and adding the metal salt solution, ammonia water, and NaOH into a reaction kettle with a peristaltic pump; carrying out the reaction for 120 hours with a reaction temperature controlled to 70° C. and a stirring speed of 200 r/min; and subjecting the resulting reaction solution to solid-liquid separation, aging, washing, drying, and sieving, to obtain the precursor Ni_{0.5}Co_{0.3}Mn_{0.2}(OH)₂, with a particle size broadening factor K=0.87; and
(2) Mixing thoroughly the aforementioned precursor and lithium carbonate at a molar ratio of 1:1.15, with the doping element M being 1500 ppm Zr and 1500 ppm Al (Zr and Al being doped in the form of Zr and Al oxides), to obtain a mixture; and subjecting the mixture to first sintering for 27 hours at 810° C. in an air atmosphere, pulverization and coating, and then to second sintering for 6 hours at 450° C. in an air atmosphere and cooling, to obtain the Zr and Al co-doped cathode material for lithium ion batteries, Li_{1.15}Ni_{0.5}Co_{0.3}Mn_{0.2}(ZrAl)_{0.03}O₂.

The cathode material Li_{1.15}Ni_{0.5}Co_{0.3}Mn_{0.2}(ZrAl)_{0.03}O₂ prepared in Comparative Example 1 is produced into a half cell and subjected to charge and discharge tests at different rates to characterize its rate performance. The capacity retention (relative to that at 1C) of the prepared cathode material Li_{1.15}Ni_{0.5}Co_{0.3}Mn_{0.2}(ZrAl)_{0.03}O₂ at different rates is shown in Table 5 below.

TABLE 5

| Rate | 2 C/1 C | 5 C/1 C | 10 C/1 C | 20 C/1 C |
|---|---|---|---|---|
| Capacity retention | 86.37 | 82.44 | 76.49 | 67.23 |
| (%) | | | | |

It can be seen from Table 5 that the capacity retention of the cathode material for lithium ion batteries of Comparative Example 1 is only 67.23% at 20C, which indicates that the cathode material for lithium ion batteries does not possess a high power characteristic.

### Comparative Example 2

A cathode material precursor in this comparative example has a chemical formula of Ni_{0.5}Co_{0.5}(OH)₂, is obviously in a shape of a stack of lamellae, and has a particle size broadening factor of 0.90, where 0.90=(Dᵥ90−Dᵥ10)/Dᵥ50.

A preparation method of the cathode material precursor in this comparative example comprises the following steps of:

According to the molar ratio of Ni:Co of 5:5, dissolving nickel acetate and cobalt acetate in deionized water to obtain a metal salt solution with a concentration of 1 mol/L, adjusting a concentration of ammonia water as a complexing agent to 0.8 g/L, and adding the metal salt solution, ammonia water, and NaOH into a reaction kettle with a peristaltic pump; carrying out the reaction for 120 hours with a reaction temperature controlled to 60° C. and a stirring speed of 400 r/min; and subjecting the resulting reaction solution to solid-liquid separation, aging, washing, drying, and sieving, to obtain the precursor Ni_{0.5}Co_{0.5}(OH)₂ with a particle size broadening factor K=0.90.

A cathode material for lithium ion batteries in this comparative example is prepared from raw materials comprising the aforementioned cathode material precursor, and has a chemical formula of Li_{1.25}Ni_{0.5}Co_{0.5}(BSr)_{0.016}O₂.

A preparation method of the cathode material for lithium ion batteries in this comparative example comprises the following steps of:

Mixing thoroughly the aforementioned precursor and lithium carbonate at a molar ratio of 1:1, with the doping element M being 600 ppm B and 1000 ppm Sr (B and Sr being doped in the form of B and Sr oxides), to obtain a mixture; and subjecting the mixture to first sintering for 18 hours at 790° C. in an air atmosphere, pulverization and coating, and then to second sintering for 5 hours at 550° C. in an air atmosphere and cooling, to obtain the cathode material for lithium ion batteries, Li_{1.25}Ni_{0.5}Co_{0.5}(BSr)_{0.016}O₂.

The high power type cathode material Li_{1.25}Ni_{0.5}Co_{0.5}(BSr)_{0.016}O₂ prepared in Comparative Example 2 is produced into a half cell and subjected to charge and discharge tests at different rates to characterize its rate performance. The capacity retention (relative to that at 1C) of the prepared high power type cathode material Li_{1.25}Ni_{0.5}Co_{0.5}(BSr)_{0.016}O₂ at different rates is shown in Table 6 below.

TABLE 6

| Rate | 2 C/1 C | 5 C/1 C | 10 C/1 C | 20 C/1 C |
|---|---|---|---|---|
| Capacity retention | 94.29 | 91.36 | 88.49 | 83.20 |
| (%) | | | | |

It can be seen from Table 6 that the capacity retention of the cathode material for lithium ion batteries of Comparative Example 2 can be up to 83.20% even at 20C, which indicates that the cathode material for lithium ion batteries possesses a high power characteristic.

1. A cathode material precursor, wherein the cathode material precursor has a chemical formula of NiₓCo_{y}Mn_{z}(OH)₂, where 0.2≤x≤1, 0≤y≤0.5, 0≤z≤0.6, and 0.8≤x+y+z≤1; the cathode material precursor is in a shape of a stack of lamella, and has a particle size broadening factor K, where K≤0.85.

2. The cathode material precursor of claim 1, wherein the cathode material precursor has 40% to 80% of {010} crystal plane family, and the {010} crystal plane family in the cathode material precursor includes active crystal planes (010), (01̅0), (100), (110), (11̅0), and (1̅00).

3. A preparation method of a cathode material precursor of claim 1, wherein the preparation method comprises steps of:
preparing a metal salt solution of nickel, cobalt and manganese; adding thereto a complexing agent and then a precipitating agent to carry out nucleation reaction; adjusting concentrations of the metal salt solution of nickel, cobalt and manganese and the complexing agent to carry out growth reaction; and carrying out filtering, aging, and drying to obtain the cathode material precursor.

4. A preparation method of a cathode material precursor of claim 2, wherein the preparation method comprises steps of:
preparing a metal salt solution of nickel, cobalt and manganese; adding thereto a complexing agent and then a precipitating agent to carry out nucleation reaction; adjusting concentrations of the metal salt solution of nickel, cobalt and manganese and the complexing agent to carry out growth reaction; and carrying out filtering, aging, and drying to obtain the cathode material precursor.

5. The preparation method of claim 3, wherein the complexing agent is a basic nitrogen-containing substance and the basic nitrogen-containing substance is ammonia water; the precipitating agent is at least one selected from a group consisting of sodium hydroxide and sodium carbonate; and the metal salt solution of nickel, cobalt and manganese is at least one selected from a group consisting of solutions of sulfates, nitrates, oxalates and hydrochlorides of nickel, cobalt and manganese.

6. The preparation method of claim 4, wherein the complexing agent is a basic nitrogen-containing substance and the basic nitrogen-containing substance is ammonia water; the precipitating agent is at least one selected from a group consisting of sodium hydroxide and sodium carbonate; and the metal salt solution of nickel, cobalt and manganese is at least one selected from a group consisting of solutions of sulfates, nitrates, oxalates and hydrochlorides of nickel, cobalt and manganese.

7. The preparation method of claim 3, wherein the metal salt solution of nickel, cobalt and manganese in the nucleation reaction has a concentration in a range from 0.5 to 2 mol/L, the metal salt solution of nickel, cobalt and manganese in the growth reaction has a concentration in a range from 1.5 to 3 mol/L; the complexing agent in the nucleation reaction has a concentration in a range from 0.5 to 2.5 g/L, the complexing agent in the growth reaction has a concentration in a range from 2 to 5 g/L; and the nucleation reaction is carried out for 24 to 50 hours, and the growth reaction is carried out for 60 to 100 hours.

8. The preparation method of claim 4, wherein the metal salt solution of nickel, cobalt and manganese in the nucleation reaction has a concentration in a range from 0.5 to 2 mol/L, the metal salt solution of nickel, cobalt and manganese in the growth reaction has a concentration in a range from 1.5 to 3 mol/L; the complexing agent in the nucleation reaction has a concentration in a range from 0.5 to 2.5 g/L, the complexing agent in the growth reaction has a concentration in a range from 2 to 5 g/L; and the nucleation reaction is carried out for 24 to 50 hours, and the growth reaction is carried out for 60 to 100 hours.

9. A cathode material for lithium ion batteries, wherein the cathode material for lithium ion batteries is prepared from raw materials comprising a cathode material precursor of claim 1.

10. A cathode material for lithium ion batteries, wherein the cathode material for lithium ion batteries is prepared from raw materials comprising a cathode material precursor of claim 2.

11. The cathode material for lithium ion batteries of claim 9, wherein the cathode material for lithium ion batteries has a chemical formula of LiₐNiₓCo_{y}Mn_{z}M_{b}O₂, where 0.9≤a≤1.4, 0.2≤x≤1, 0≤y≤0.5, 0≤z≤0.6, 0≤b≤0.1, 0.8≤x+y+z≤1, 1≤a/(x+y+z)≤1.5; and M is at least one selected from a group consisting of elements B, Al, Mg, Ti, Fe, Zn, Ga, Ge, Sr, Y, Zr, Nb, Mo, Sn, Sb, La, Ce, W, and Ta.

12. The cathode material for lithium ion batteries of claim 10, wherein the cathode material for lithium ion batteries has a chemical formula of LiaNixCoyMnzMbO2, where 0.9≤a≤1.4, 0.2≤x≤1, 0≤y≤0.5, 0≤z≤0.6, 0≤b≤0.1, 0.8≤x+y+z≤1, 1≤a/(x+y+z)≤1.5; and M is at least one selected from a group consisting of elements B, Al, Mg, Ti, Fe, Zn, Ga, Ge, Sr, Y, Zr, Nb, Mo, Sn, Sb, La, Ce, W, and Ta.

13. A preparation method of a cathode material for lithium ion batteries of claim 9, wherein the preparation method comprises steps of:
mixing a cathode material precursor, a lithium source and an additive to obtain a mixture, subjecting the mixture to first sintering and pulverization, and then to second sintering and cooling, to obtain the cathode material for lithium ion batteries.

14. A preparation method of a cathode material for lithium ion batteries of claim 10, wherein the preparation method comprises steps of:
mixing a cathode material precursor, a lithium source and an additive to obtain a mixture, subjecting the mixture to first sintering and pulverization, and then to second sintering and cooling, to obtain the cathode material for lithium ion batteries.

15. The preparation method of claim 13, wherein the lithium source is at least one selected from a group consisting of lithium carbonate and lithium hydroxide; and the additive is at least one selected from a group consisting of oxides of B, Al, Mg, Ti, Fe, Zn, Ga, Ge, Sr, Y, Zr, Nb, Mo, Sn, Sb, La, Ce, W, and Ta.

16. The preparation method of claim 14, wherein the lithium source is at least one selected from a group consisting of lithium carbonate and lithium hydroxide; and the additive is at least one selected from a group consisting of oxides of B, Al, Mg, Ti, Fe, Zn, Ga, Ge, Sr, Y, Zr, Nb, Mo, Sn, Sb, La, Ce, W, and Ta.

17. A battery, wherein the battery comprises a cathode material for lithium ion batteries of claim 9.

18. A battery, wherein the battery comprises a cathode material for lithium ion batteries of claim 10.

19. A battery, wherein the battery comprises a cathode material for lithium ion batteries of claim 11.

20. A battery, wherein the battery comprises a cathode material for lithium ion batteries of claim 12.
